(19) United States
(12) Patent Application Publication
(10) Pub. No.: US 2022/0071421 A1
(43) Pub. Date: Mar. 10, 2022

(54) METHOD OF MANUFACTURING DISPOSABLE STRAWS AND CUP LIDS

(71) Applicant: ARTEM KRUGLYAKOV, KYIV (UA)

(72) Inventor: ARTEM KRUGLYAKOV, KYIV (UA)

(21) Appl. No.: 17/066,024

(22) Filed: Oct. 8, 2020

(30) Foreign Application Priority Data
Nov. 7, 2019 (UA) 2019 10982

(51) Int. Cl. A47G 21/18; B31C 3/00; D21J 5/00; A47G 19/22; B31C 11/06

(52) U.S. Cl. CPC A47G 21/18; B31C 3/00; A47G 2400/10; A47G 19/2272; B31C 11/06; D21J 5/00

(57) ABSTRACT

The present invention provides a method for the manufacture of disposable straws (preferably having an average length between 10 cm and 30 cm) and cup lids from fibrous materials preferably including paper, cardboard, plant fibers, animal fibers, artificial fibers, fabrics made from one or more thereof; or non-woven materials made from one or more thereof. These manufacturing steps generally and preferably include: (1) feeding a strip of fibrous material into a tank of adhesive or glue for treating fibrous material with a solution of cellulose ester in a solvent; (2) feeding the treated fibrous material into a press or spiral winding unit; (3) drying, cutting, and forming the fibrous material into disposable straws or cup lids; (4) testing the formed disposable straws or cup lids for quality control; and (5) packaging the disposable straws or cup lids.

### FIELD OF THE INVENTION

Applicant hereby claims priority from the Ukraine patent application no. 2019 10982 filed on Nov. 7, 2019.

The present invention relates to a method of manufacturing disposable straws and cup lids, which have high consumer properties and completely decompose in the environment without polluting it.

### BACKGROUND OF THE INVENTION

There presently exists a large number of biodegradable disposable products that are produced in the world, such as paper straws, paper cups, and paper plates. Other biodegradable disposable products include PLA (polylactic acid or polylactide) thermoplastic cutlery, starch-polyethylene composites, laminated paper to-go boxes, and other similar products. All of these products have certain disadvantages. For example, paper straws tend to break down quickly both in hot and cold beverages. Further, paper cups, plates, and to-go boxes have a polyethylene lamination layer that is not biodegradable and contributes to the planet's contamination with micro-plastics. PLA thermoplastic products require special composting methods and do not always meet consumer requirements. In addition, there are to-go boxes, plates, and paper cup lids that are cast from the paper pulp in a method of casting into forming mesh matrices, and still, they tend to break-down quickly when in contact with wet foods or liquids.

The proposed manufacturing process provides disposable paper and cardboard products with significant increased moisture resistance with improved biodegradability. The essence (novelty) of the proposed technology is to use for surface sizing, for internal sizing, for lamination, and for adhesive bonding, use of cellulose ether solutions in organic solvents, mixed with plasticizers and fillers to manufacture biodegradable disposable products, namely, disposable straws and cup lids, having improved durability and moisture resistance.

### DESCRIPTION OF THE PRIOR ART

Prior art Russian Patent No. RU 2334620 C1 describes a method of manufacturing utensils for food. According to the known method, the cardboard blanks are loaded onto the carousel mechanism where lateral cutting and glue is applied, followed by twisting and thermal bonding of the opposite sides to form a seam.

In addition, this method includes cutting the blanks of the bottom part of the cardboard canvas, connecting the side by cutting the bottom, then rolling the bottom, and finally molding the obtained product. Moreover, an insert made of a polymeric material is additionally fed to the carousel mechanism, and the outer side of the polymer insert is aligned and glued to the inner side of the side cutout. The connection is made using the side cutout and the bottom part by gluing to the bottom of the polymer insert bottom cardboard blank. An aqueous dispersion of a synthetic resin is used as the adhesive for the connection. The connection of the side seam is carried out at a temperature of 520-560° C. Bonding of the sidecut and the polymer insert is carried out at a temperature of 360-390° C., and gluing the bottom to the bottom of the polymer insert is carried out at a temperature of 190-210° C. The known method provides a convenient use of disposable utensils. The disadvantage of this method is that the dishes made according to the method have low consumer properties; in particular, the dishes made in this way get wet quickly and become unusable. Also, such dishes contaminate the environment when they decompose.

However, the prior art does not disclose an improved method of manufacturing disposable straws and cup lids, which have high consumer properties and which completely decompose in the environment without polluting it, as claimed and disclosed herein.

### OBJECTS OF THE INVENTION

It is an object of the present invention to provide a method of manufacturing disposable, biodegradable, and hygienic straws for drinks and cup lids.

Another object of the present invention is to provide a method of manufacturing disposable, biodegradable, and hygienic straws for drinks and cup lids that are modified with cellulose ethers (such as cellulose acetate, ethylcellulose cellulose nitrate, acetylphthalyl cellulose, hydroxypropyl methylcellulose, cellulose propionate, cellulose butyrate) dissolved in solvents (acetone, ethanol, ethyl acetate, glycerine acetate, acetic acid).

Another object of the present invention is to provide a method of manufacturing disposable, biodegradable, and hygienic straws for drinks and cup lids that optionally include plasticizers such as glycerin, glycerol acetate, polyethylene glycol, or polyethylene oxide.

Another object of the present invention is to provide a method of manufacturing disposable, biodegradable, and hygienic straws for drinks and cup lids that optionally include fillers such as starch, micro cellulose, wood flour, talc, aerosil, carbon, bone meal.

Another object of the present invention is to provide a method of manufacturing disposable, biodegradable, and hygienic straws for drinks and cup lids that optionally include external and internal sizing.

Another object of the present invention is to provide a method of manufacturing disposable, biodegradable, and hygienic straws for drinks and cup lids that optionally include a laminating agent in the production process.

Another object of the present invention is to provide a method of manufacturing disposable, biodegradable, and hygienic straws for drinks and cup lids made of paper, cardboard, plant fibers (flax, hemp, jute, cotton, coconut), fibers of animal origin (wool of sheep, camel, plumage, and down of birds), fibers of artificial origin (viscose, acetate, amia copper, casein, soy, zein, gluten, gelatin, chitin, collagen, alginate), as well as fabrics and nonwoven materials made of these fibers.

Another object of the present invention is to provide a method of manufacturing disposable, biodegradable, and hygienic straws for drinks and cup lids having temperature stability over a wide temperature range (from −30 to +140 degrees Celsius).

Another object of the present invention is to provide a method of manufacturing disposable, biodegradable, and hygienic straws for drinks and cup lids having a long shelf life under proper storage conditions while also having a short biodegradation period both in composting systems and in natural conditions.

Another object of the present invention is to provide a method of manufacturing disposable, biodegradable, and hygienic straws for drinks and cup lids having optimal production costs provided by the wide availability of components, the manufacturability of their processing on existing equipment, and the relatively low price of the initial component.

### SUMMARY OF THE INVENTION

The present invention provides a method for the manufacture of disposable straws (preferably having an average length between 10 cm and 30 cm) and cup lids from fibrous materials preferably including paper, cardboard, plant fibers, animal fibers, artificial fibers, fabrics made from one or more thereof, or non-woven materials made from one or more thereof. These manufacturing steps generally and preferably include: (1) feeding a strip of fibrous material into a tank of adhesive or glue for treating fibrous material with a solution of cellulose ester in a solvent; (2) feeding the treated fibrous material into a press or spiral winding unit; (3) drying, cutting, and forming the fibrous material into disposable straws or cup lids; (4) testing the formed disposable straws or cup lids for quality control; and (5) packaging the disposable straws or cup lids.

Preferably the cellulose ester used for treating the fibrous material can include: cellulose acetate, ethylcellulose cellulose nitrate, acetylphthalyl cellulose, hydroxypropyl methylcellulose, cellulose propionate, or cellulose butyrate. Also, the cellulose ester used for treating the fibrous material is dissolved in a solvent preferably including acetone, ethanol, ethyl acetate, glycerol acetate, acetic acid, or mixtures thereof. Further, the dissolved cellulose ester in a solvent used for treating the fibrous material preferably has a concentration of 10% to 40% by weight of cellulose ester.

In addition, the cellulose ester solution used for treating the fibrous material can further include plasticizers, fillers, or dyes which provide enhanced qualities to the manufactured disposable straws and cup lids, including increased durability, flexibility, and color. For instance, plasticizers can be added to the cellulose ester solution which increase the plasticity and flexibility of the produced disposable straws and cup lids, while reducing their brittleness. Preferred plasticizers can include glycerol, PEG (polyethylene glycol), or glycerol acetate. Further, fillers can be added to the cellulose ester solution for increasing durability of the produced disposable straws and cup lids, which preferably include: microcrystalline cellulose, starch, wood flour, activated carbon powder, bone meal, mineral fillers, talc, chalk, gypsum, or Aerosil. Finally, dyes can be added to the cellulose ester solution for providing color to the produced disposable straws and cup lids. These dyes preferably include: mineral powder-based dyes, plant juice-based dyes, or fruit juice based dyes.

### DESCRIPTION OF THE DRAWINGS

FIG. 1 shows an exemplary schematic diagram of a paper tube manufacturing process for the manufacture of a disposable straw.

FIG. 2 shows an exemplary schematic diagram of a manufacturing process for the manufacture of a disposable cup lid.

FIG. 3 shows an exemplary schematic diagram of a manufacturing process for the manufacture of a disposable straw.

### DETAILED DESCRIPTION OF THE PREFERRED EMBODIMENT

The present invention provides a method of manufacturing disposable straws and cup lids from paper, fabrics, or nonwovens from fibrous materials of natural plant or animal origin that is treated with solutions of cellulose esters in solvents. The concentration of cellulose ester has a broad concentration range of 10% to 40% by weight of cellulose ester and preferably has a concentration range of 30% to 40% by weight of cellulose ester. The manufacturing processes disclosed herein can also be applied to manufacturing disposable tableware, packaging, cutlery, plates, cups, etc.

In a preferred embodiment of the present invention, fibrous materials are treated with a solution of cellulose acetate in ethyl acetate, plasticized with glycerin acetate, under cool or temperate temperatures (from 0 to +30 degrees Celsius). Also, the invention includes treating fibrous materials with a solution of cellulose acetate in glycerol acetate under warm or hot temperatures (from +120 to +210 degrees Celsius). In this method, the solution of cellulose acetate in glycerol acetate under warm or hot temperatures acts as a thermal glue as an adhesive, as an internal sizing (gluing), as an external sizing (gluing), or as a laminating agent using a solution of cellulose acetate in glycerol acetate is preferable because it is inexpensive, non-toxic, has good biodegradability qualities, and is readily available and can be procured in large quantities.

More specifically, the present invention provides a method of manufacturing, preferably, disposable straws and cup lids, as well as disposable cutlery and other disposable consumer products from paper, fabrics, or nonwovens from fibrous materials of natural plant or animal origin that is treated with solutions of cellulose esters in solvents, and preferably treated with a solution of cellulose acetate in glycerol acetate. As compared to commonly known treatments of using glue (adhesive) and internal and external sizing or dispersion-lamination agents, treating fibrous materials used to make straws and cup lids with solutions of, for example, cellulose ether in ethyl acetate with glycerol acetate, or a solution of cellulose acetate in glycerol acetate provides increased consumer qualities to the finished disposable products, e.g., straws and cup lids. These improved qualities include providing a high level of water resistance and durability when the products are immersed in a liquid, while at the same time providing easy disposal biodegradation in natural conditions and during composting.

The treated fibrous materials used to form disposable products, e.g., straws and cup lids, can be formed from (but not limited to) the following fibrous materials: paper; cardboard; plant fibers made of linen, hemp, jute, cotton, or coconut; animal fiber made of sheep wool, camel wool, feathers, or bird down; artificial fibers such as those made of viscose, acetate, copper-ammonia, casein, soy, zein, gluten, gelatin, collagen, chitin, alginate; as well as other fabrics and nonwoven materials based on the aforementioned fibers.

In addition, the cellulose ester solution used for treating the fibrous material can further include plasticizers, fillers, or dyes which provide enhanced qualities to the manufactured disposable straws and cup lids, including increased durability, flexibility, and color. For instance, plasticizers can be added to the cellulose ester solution which increase the plasticity and flexibility of the produced disposable straws and cup lids, while reducing their brittleness. Preferred plasticizers can include glycerol, PEG (polyethylene glycol), or glycerol acetate. Further, fillers can be added to the cellulose ester solution for increasing durability of the produced disposable straws and cup lids, which preferably include: microcrystalline cellulose, starch, wood flour, activated carbon powder, bone meal, mineral fillers, talc, chalk, gypsum, or Aerosil. Finally, dyes can be added to the cellulose ester solution for providing color to the produced disposable straws and cup lids. These dyes preferably include: mineral powder-based dyes, plant juice-based dyes, or fruit juice based dyes. For instance, a solution of cellulose acetate in glycerin acetate may be used optionally including fillers such as starch, micro cellulose, wood flour, talc, aerosil, carbon, bone meal, with or without natural food coloring.

Furthermore, the treated fibrous materials may be formed into preferably, disposable straws and cup lids, as well as disposable cutlery and other disposable consumer products using various known methods of extrusion, stamping, thermal vacuum forming (thermoforming), and injection molding.

The preferred embodiment of the invention will be described in more detail in the examples below.

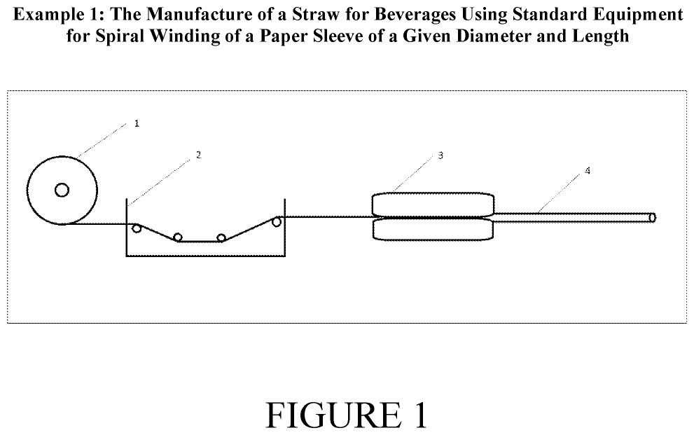

FIG. 1 shows a schematic illustration of a paper tube manufacturing process for the manufacture of a disposable straw. A strip of fibrous material, in this case paper from roll 1, is fed into a tank of adhesive 2 for treating the paper with a solution of cellulose ester in a solvent, here, a solution of cellulose acetate in ethyl acetate. The concentration of cellulose acetate preferably has a concentration of 30% to 40% by weight of cellulose acetate.

Then the treated paper is fed into a spiraling winding unit 3 for forming an endless tube 4. Next (not shown in the figure), the endless tube 4 is fed into a cutting unit for cutting the endless tube into segmented tubes each having a predetermined length, preferably having an average length between 10 cm and 30 cm. Then, the cut segmented tubes are fed into a drying chamber for evaporating the solution from the segmented tubes. When the segmented tubes are dried, they form disposable straws. The dried disposable straws are then tested for quality control and then packaged.

Although the above example shows rolled paper as the fibrous material to be treated, other types of fibrous materials may be used. For instance, fibrous material can be selected from the group consisting of paper, cardboard, plant fibers, animal fibers, artificial fibers, fabrics made from one or more thereof, and non-woven materials made from one or more thereof.

Furthermore, the solution of cellulose ester in a solvent can have a concentration of 10% to 40% by weight of cellulose ester. Also, the cellulose ester can be chosen from one or more of the following: cellulose acetate, ethylcellulose cellulose nitrate, acetylphthalyl cellulose, hydroxypropyl methylcellulose, cellulose propionate, and cellulose butyrate. Further, the solvent can be selected from the group consisting of acetone, ethanol, ethyl acetate, glycerol acetate, acetic acid, and mixtures thereof.

In addition, plasticizers, fillers, or dyes may also be added to the solution of cellulose ester in a solvent. Plasticizers may be selected from the group consisting of glycerol, PEG, and glycerol acetate. Also, fillers may be selected from the group consisting of microcrystalline cellulose, starch, wood flour, activated carbon powder, bone meal, mineral fillers, talc, chalk, gypsum, and Aerosil. Finally, dyes may be selected from the group consisting of mineral powder-based dyes, plant juice-based dyes, and fruit juice based dyes.

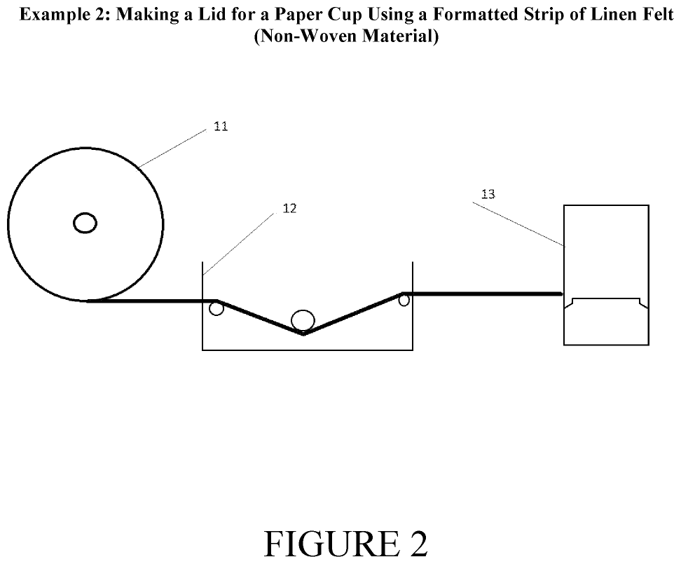

FIG. 2 shows a schematic illustration of a manufacturing process for the manufacture of a disposable cup lid. According to this example, a strip of fibrous material, in this case rolled non-woven material, i.e., linen felt, is unwound from a roll 11. The unwound linen felt is then fed into a tank of glue 12 for treating the fibrous material with a solution of cellulose ester in a solvent and containing a plasticizer. Here, the preferable solution of cellulose ester in a solvent is a solution of cellulose acetate, in ethyl acetate with the addition of glycerol acetate as a plasticizer, wherein the concentration of cellulose acetate preferably has a concentration of 30% to 40% by weight of cellulose acetate. Also, the concentration of the plasticizer, glycerol acetate, has a concentrate of 30 to 100% by weight of glycerol acetate.

The treated linen felt is then fed into a press 13 wherein the treated fibrous material is simultaneously molded cut and contoured into the shape of a cup lid, as well as dried. More specifically, the mold is made in the form of a lid for a paper cup and contains micro-holes for removing solvent vapors, a circular cutter for cutting around the lid's edge, and a device for heating and removing the molded product. At the end of the steps of forming, die-cutting, and drying, the finished cup lid product is removed from the press and enters the packaging step. This cycle is then repeated. The dried disposable cup lids are then tested for quality control and then packaged.

Although the above example shows non-woven material, i.e., linen felt, as the fibrous material to be treated for manufacturing disposable cup lids, other types of fibrous materials may be used. For instance, fibrous material can be selected from the group consisting of paper, cardboard, plant fibers, animal fibers, artificial fibers, fabrics made from one or more thereof, and non-woven mate-rials made from one or more thereof. Further, the aforementioned manufacturing process could also be used to produce disposable cutlery such as spoons, forks, and knives. For example, for manufacturing cutlery, it is possible to use several strips of paper instead of one strip of woven or non-woven material, which are each independently treated in the tank of glue 12. The treated paper is then thermoformed into disposable cutlery, which are then stacked.

Furthermore, the solution of cellulose ester in a solvent can have a concentration of 10% to 40% by weight of cellulose ester. Also, the cellulose ester can be chosen from one or more of the following: cellulose acetate, ethylcellulose cellulose nitrate, acetylphthalyl cellulose, hydroxypropyl methylcellulose, cellulose propionate, and cellulose butyrate. Further, the solvent can be selected from the group consisting of acetone, ethanol, ethyl acetate, glycerol acetate, acetic acid, and mixtures thereof.

In addition, plasticizers, fillers, or dyes may also be added to the solution of cellulose ester in a solvent. Plasticizers may be selected from the group consisting of glycerol, PEG, and glycerol acetate and can have a concentration of 10-150% by weight. Also, fillers may be select-ed from the group consisting of microcrystalline cellulose, starch, wood flour, activated carbon powder, bone meal, mineral fillers, talc, chalk, gypsum, and Aerosil. Finally, dyes may be selected from the group consisting of mineral powder-based dyes, plant juice-based dyes, and fruit juice based dyes.

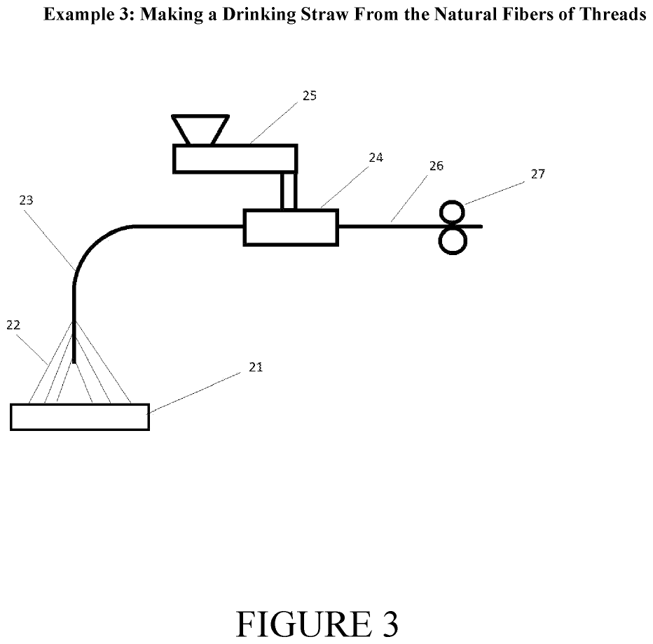

FIG. 3 shows a schematic illustration of a manufacturing process for the manufacture of a disposable straw. In accordance with this example, threads made from natural fibers 22, e.g., cotton threads, linen threads, hemp threads, rayon threads, acetate threads, protein threads, etc., are weaved into an endless sleeve 23 using a cord spinning knot 21. Next, the sleeve 23 is pulled through an extruder with the help of a pulling roller unit 27 and enters the extrusion head 24 for stretching and treating the endless sleeve 23 with a solution of cellulose ester in a solvent, in this case, cellulose acetate in glycerol acetate. Specifically, the solution of cellulose acetate in glycerol acetate is injected using the extruder 25 at a temperature above the melting point of the solution and is evenly distributed over the surface of the endless sleeve 23. The solution of cellulose acetate in glycerol acetate preferably has a concentration of 30% to 50% by weight of glycerol acetate. Alternatively, the solution of cellulose acetate in glycerol acetate has a concentration of 5 to 7 parts by weight of glycerol acetate per 10 parts by weight of cellulose acetate or 1 to 15 parts by weight of glycerol acetate per 10 parts by weight of cellulose acetate.

Next, the endless sleeve 23 is cooled until it hardens and forms an endless composite tube. The endless composite tube then enters a cutting zone for cutting the endless composite tube into straws (not shown in the figure) each having a predetermined length, and each having an average length between 10 cm and 30 cm. The cut disposable straws are then tested for quality control and then packaged in a packing zone.

The method of this invention can be implemented by other production lines of equipment, materials, tools, and operations, which confirms the industrial applicability of this invention.

For instance, although the above example shows threads made from natural fibers as the fibrous material to be treated, other types of fibrous materials may be used. For instance, fibrous material can be selected from the group consisting of paper, cardboard, plant fibers, animal fibers, artificial fibers, fabrics made from one or more thereof, and nonwoven mate-rials made from one or more thereof.

Furthermore, the solution of cellulose ester in a solvent can have a concentration of 10% to 40% by weight of cellulose ester. Also, the cellulose ester can be chosen from one or more of the following: cellulose acetate, ethyl-cellulose cellulose nitrate, acetylphthalyl cellulose, hydroxypropyl methylcellulose, cellulose propionate, and cellulose butyrate. Further, the solvent can be selected from the group consisting of acetone, ethanol, ethyl acetate, glycerol acetate, acetic acid, and mixtures thereof.

In addition, plasticizers, fillers, or dyes may also be added to the solution of cellulose ester in a solvent. Plasticizers may be selected from the group consisting of glycerol, PEG, and glycerol acetate. Also, fillers may be select-ed from the group consisting of microcrystalline cellulose, starch, wood flour, activated carbon powder, bone meal, mineral fillers, talc, chalk, gypsum, and Aerosil. Finally, dyes may be selected from the group consisting of mineral powder-based dyes, plant juice-based dyes, and fruit juice based dyes.

It should be understood that the above examples and embodiments are illustrative only, and various modifications and variations are known to those skilled in the art, which are encompassed by the spirit of the present invention.

It should be understood that the above information in no way limits the scope of the rights under the application, in no way limits the number of possible options for implementation in accordance with the technical solution, but only explains the features of the technical solution set out in the formula.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

### Advantages of the Present Invention

It is an advantage of the present invention to provide a method of manufacturing disposable, biodegradable, and hygienic straws for drinks and cup lids.

Another advantage of the present invention is to provide a method of manufacturing disposable, biodegradable, and hygienic straws for drinks and cup lids that are modified with cellulose ethers (such as cellulose acetate, ethylcellulose cellulose nitrate, acetylphthalyl cellulose, hydroxypropyl methylcellulose, cellulose propionate, cellulose butyrate) dissolved in solvents (acetone, ethanol, ethyl acetate, glycerine acetate, acetic acid).

Another advantage of the present invention is to provide a method of manufacturing disposable, biodegradable, and hygienic straws for drinks and cup lids that optionally include plasticizers such as glycerin, glycerol acetate, polyethylene glycol, or polyethylene oxide.

Another advantage of the present invention is to provide a method of manufacturing disposable, biodegradable, and hygienic straws for drinks and cup lids that optionally include fillers such as starch, micro cellulose, wood flour, talc, aerosil, carbon, bone meal.

Another advantage of the present invention is to provide a method of manufacturing disposable, biodegradable, and hygienic straws for drinks and cup lids that optionally include external and internal sizing.

Another advantage of the present invention is to provide a method of manufacturing disposable, biodegradable, and hygienic straws for drinks and cup lids that optionally include a laminating agent in the production process.

Another advantage of the present invention is to provide a method of manufacturing disposable, biodegradable, and hygienic straws for drinks and cup lids made of paper, cardboard, plant fibers (flax, hemp, jute, cotton, coconut), fibers of animal origin (wool of sheep, camel, plumage, and down of birds), fibers of artificial origin (viscose, acetate, amia copper, casein, soy, zein, gluten, gelatin, chitin, collagen, alginate), as well as fabrics and nonwoven materials made of these fibers.

Another advantage of the present invention is to provide a method of manufacturing disposable, biodegradable, and hygienic straws for drinks and cup lids having temperature stability over a wide temperature range (from −30 to +140 degrees Celsius).

Another object of the present invention is to provide a method of manufacturing disposable, biodegradable, and hygienic straws for drinks and cup lids having a long shelf life under proper storage conditions while also having a short biodegradation period both in composting systems and in natural conditions.

Another advantage of the present invention is to provide a method of manufacturing disposable, biodegradable, and hygienic straws for drinks and cup lids having optimal production costs provided by the wide availability of components, the manufacturability of their processing on existing equipment, and the relatively low price of the initial components.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A method for the manufacture of a disposable straw comprising the steps of:
a. feeding a strip of fibrous material into a tank of adhesive for treating said fibrous material with a solution of cellulose ester in a solvent having a concentration of 10% to 40% by weight of cellulose ester;
b. feeding said treated fibrous material into a spiral winding unit for forming an endless tube;
c. feeding said endless tube into a cutting unit for cutting said endless tube into segmented tubes each having a predetermined length; and
d. feeding said segmented tubes into a drying chamber for evaporating said solution from said segmented tubes, wherein said dried segmented tubes form disposable straws.

2. A method of manufacturing a disposable straw according to claim 1, wherein said fibrous material is selected from the group consisting of paper, cardboard, plant fibers, animal fibers, artificial fibers, fabrics made from one or more thereof, and non-woven materials made from one or more thereof.

3. A method of manufacturing a disposable straw according to claim 1, wherein said cellulose ester is chosen from one or more of the following: cellulose acetate, ethylcellulose cellulose nitrate, acetylphthalyl cellulose, hydroxypropyl methylcellulose, cellulose propionate, and cellulose butyrate.

4. A method of manufacturing a disposable straw according to claim 1, wherein said solvent is selected from the group consisting of acetone, ethanol, ethyl acetate, glycerol acetate, acetic acid, and mixtures thereof.

5. A method of manufacturing a disposable straw according to claim 1, wherein said solution of cellulose ester further includes plasticizers, fillers, or dyes.

6. A method of manufacturing a disposable straw according to claim 5, wherein said plasticizers are selected from the group consisting of glycerol, PEG, and glycerol acetate.

7. A method of manufacturing a disposable straw according to claim 5, wherein said fillers are selected from the group consisting of microcrystalline cellulose, starch, wood flour, activated carbon powder, bone meal, mineral fillers, talc, chalk, gypsum, and Aerosil.

8. A method of manufacturing a disposable straw according to claim 5, wherein said dyes are selected from the group consisting of mineral powder-based dyes, plant juice-based dyes, and fruit juice based dyes.

9. A method for the manufacture of a disposable cup lid comprising the steps of:
a. feeding a strip of fibrous material into a tank of glue for treating said fibrous material with a solution of cellulose ester in a solvent having a concentration of 10% to 40% by weight of cellulose ester and containing a plasticizer having a concentration of 10% to 150% by weight;
b. feeding said treated fibrous material into a press for drying said treated fibrous material and for forming unfinished disposable cup lids;
c. cutting said unfinished disposable cup lids to form finished disposable cup lids; and
d. removing said finished disposable cup lids from said press area.

10. A method of manufacturing a disposable cup lid according to claim 9, wherein said fibrous material is selected from the group consisting of paper, cardboard, plant fibers, animal fibers, artificial fibers, fabrics made from one or more thereof, and nonwoven materials made from one or more thereof.

11. A method of manufacturing a disposable cup lid according to claim 9, wherein said plasticizer is selected from the group consisting of glycerol, PEG, glycerol acetate, and a combination thereof.

12. A method of manufacturing a disposable cup lid according to claim 9, wherein said cellulose ester is chosen from one or more of the following: cellulose acetate, ethylcellulose cellulose nitrate, acetylphthalyl cellulose, hydroxypropyl methylcellulose, cellulose propionate, and cellulose butyrate.

13. A method of manufacturing a disposable cup lid according to claim 9, wherein said solvent is selected from the group consisting of acetone, ethanol, ethyl acetate, glycerol acetate, acetic acid, and mixtures thereof.

14. A method of manufacturing a disposable cup lid according to claim 9, wherein said solution of cellulose ester further comprises fillers or dyes.

15. A method of manufacturing a disposable cup lid according to claim 14, wherein said fillers are selected from the group consisting of microcrystalline cellulose, starch, wood flour, activated carbon powder, bone meal, mineral fillers, talc, chalk, gypsum, and Aerosil.

16. A method of manufacturing a disposable cup lid according to claim 16, wherein said dyes are selected from the group consisting of mineral powder-based dyes, plant juice-based dyes, and fruit juice based dyes.

17. A method for the manufacture of a disposable straw comprising the steps of:
a. using a cord spinning device to weave threads of fibrous material into an endless sleeve;
b. pulling said endless sleeve through an extruder for treating said endless sleeve with a solution of cellulose ester in a solvent at a temperature above the melting point of the specified solution;
c. cooling said endless sleeve until it hardens and forms an endless composite tube; and
d. cutting said endless composite tube into disposable straws having a predetermined length.

18. A method of manufacturing a disposable straw according to claim 17, wherein said threads of fibrous material are selected from the group consisting of cotton threads, linen threads, hemp threads, rayon threads, acetate threads, and protein threads.

19. A method of manufacturing a disposable straw according to claim 17, wherein said cellulose ester is chosen from one or more of the following: cellulose acetate, ethylcellulose cellulose nitrate, acetylphthalyl cellulose, hydroxypropyl methylcellulose, cellulose propionate, and cellulose butyrate.

20. A method of manufacturing a disposable straw according to claim 17, wherein said solvent is selected from the group consisting of acetone, ethanol, ethyl acetate, glycerol acetate, acetic acid, and mixtures thereof.

21. A method of manufacturing a disposable straw according to claim 19, wherein said solution of cellulose ester in a solvent is a solution of cellulose acetate in glycerol acetate having a concentration of 5 to 7 parts by weight of glycerol acetate per 10 parts by weight of cellulose acetate.

22. A method of manufacturing a disposable straw according to claim 19, wherein said solution of cellulose ester in a solvent is a solution of cellulose acetate in glycerol acetate having a concentration of 1 to 15 parts by weight of glycerol acetate per 10 parts by weight of cellulose acetate.

23. A method of manufacturing a disposable straw according to claim 17, wherein said solution of cellulose ester further comprises plasticizers, fillers, or dyes.

24. A method of manufacturing a disposable straw according to claim 23, wherein said plasticizers are selected from the group consisting of glycerol, PEG, and glycerol acetate.

25. A method of manufacturing a disposable straw according to claim 23, wherein said fillers are selected from the group consisting of microcrystalline cellulose, starch, wood flour, activated carbon powder, bone meal, mineral fillers, talc, chalk, gypsum, and Aerosil.

26. A method of manufacturing a disposable straw according to claim 23, wherein said dyes are selected from the group consisting of mineral powder-based dyes, plant juice-based dyes, and fruit juice based dyes.
